(19) United States
(12) Patent Application Publication
(10) Pub. No.: US 2011/0010472 A1
(43) Pub. Date: Jan. 13, 2011

(54) GRAPHIC ACCELERATOR AND GRAPHIC ACCELERATING METHOD

(76) Inventor: Se Jin Kang, Seoul (KR)

Correspondence Address: BIRCH STEWART KOLASCH & BIRCH, PO BOX 747, FALLS CHURCH, VA, 22040-0747, US

(21) Appl. No.: 12/919,307

(22) PCT Filed: Feb. 23, 2009
(86) PCT No.: PCT/KR09/00850

§ 371 Date: Aug. 25, 2010

(30) Foreign Application Priority Data
Feb. 27, 2008 (KR) 10-2008-0017708

(51) Int. Cl. G06F 13/28; G06F 12/06

(52) U.S. Cl. 710/24; 710/22; 711/106; 711/E12.078

(57) ABSTRACT

A graphic accelerator including a frame memory and the same interface as a memory of a processor and a graphic accelerating method are provided. The graphic accelerator includes: a frame memory; an accelerator controller having the same interface as a memory of the processor on an input side and recording data, which should be transmitted from the processor to the display device, in the frame memory; and a display DMA (Direct Memory Access) transmitting the data recorded in the frame memory to the display device in a DMA manner. A memory bandwidth of the processor is not reduced even by continuous reading operations based on DMA transmission of the display device, by recording data corresponding to the frame memory in the graphic accelerator disposed outside the processor.

### CROSS-REFERENCE TO RELATED APPLICATIONS

This application claims foreign priority benefits under 35 U.S.C. .sctn. 119(a)-(d) to PCT/KR2009/000850, filed Feb. 23, 2009, which is hereby incorporated by reference in its entirety.

### BACKGROUND

The present invention relates to a graphics accelerator, and more particularly, to a graphic accelerator including a frame memory and an interface such as a memory of a processor and a graphic accelerating method.

A multimedia processor can transmit data to an externally-connected display device so as to enable a user to visually confirm details thereof. In this case, the data to be displayed (for example, objects, video data, GUI (Graphic User Interface), and the like) is recorded in a specific area of a memory disposed in the processor or connected to the processor. The display device connected to the multimedia processor reads and outputs the data through a DMA (Direct Memory Access) operation to realize the display. Here, the processor may be disposed in a mobile device (such as a mobile communication terminal and a smart phone) and the display device may be an LCD, a TV, a projector, or a monitor.

FIG. 1 is a block diagram illustrating the configuration of a processor connected to a display device to share a memory therewith. FIG. 2 is a block diagram illustrating the configuration of a processor including a particular frame memory therein.

The processor 100 includes a processor core 101, a two-dimensional/three-dimensional graphic processing unit 102, a video codec 103, a JPEG processing unit 104, an image signal processing unit 105, and a display DMA 106, and shares and accesses a memory 110 via a memory controller 107.

The processor core 101 controls the elements of the processor 100 and controls communications with an external device (such as a display device 120) to perform basic functions of the processor 100. The two-dimensional/three-dimensional graphic processing unit 102 performs functions involved in a two-dimensional graphic including plane coordinates and color values or a three-dimensional graphic including dots (vectors), lines, and color values. The video codec 103 encodes and/or decodes multimedia data using a predetermined encoding method. The JPEG processing unit 104 compresses a still image such as a photograph using a JPEG compressing technique. The image signal processing unit 105 processes an image signal input from an image sensor or the like to enable other processing units to utilize the image signal. The display DMA 106 transmits data stored in a predetermined area of the memory 110 to the display device 120 in a DMA manner so as to display the data.

A particular area for storing data to be displayed by the display device 120 is defined in the memory 110 and is called a frame memory area.

When various elements update the frame memory area while performing their functions, the display DMA 330 continuously outputs data stored in the frame memory area to the externally-connected display device 120. When a particular memory is not included in the external display device 120, the data in the frame memory area of the memory 110 should be periodically output in accordance with a refresh rate. A TV or a display device having a large screen size may require a higher refresh rate.

The periodic output of the data in the frame memory area in accordance with the refresh rate affects the computing power of the processor core 101. When the external display device 120 periodically accesses the frame memory area of the memory 110 and outputs the data therefrom, the processor core 101 forms a bottleneck in inputting and outputting the data to and from the memory 110, and thus the computing power thereof is deteriorated. That is, there is a problem that a memory bandwidth is narrowed due to the external display device 120. Here, the memory bandwidth means a frequency or a bandwidth allowing access to the memory (reading or writing data) per unit time and the unit is defined as bytes/sec. That is, the memory bandwidth means a data amount accessible within a predetermined time.

The data rate, that is, the memory bandwidth, at which the processing units of the processor 100 can access the shared memory 110 is always set to be smaller than the maximum data rate, that is, the maximum memory bandwidth, which a single unit can access the memory. Accordingly, the memory bandwidth which can be shared by the processing units, that is, the data amount accessible within a unit time, increases as the number of processing units sharing the memory 110 decreases.

An example where the frame memory 108 is separated from the memory 110 and is disposed in a particular memory space of the processor 100 is shown in FIG. 2. In this case, the screen size to be displayed is limited depending on the size of the frame memory 108. Accordingly, when it is intended to display a larger screen, the frame memory should be also enlarged, thereby causing a problem in that a chip corresponding to the processor 100 should be separately manufactured.

### SUMMARY

Therefore, a technical goal of the invention is to provide a graphic accelerator and a graphic accelerating method, which need not reduce a memory bandwidth of a processor even by continuous reading operations based on DMA transmission of a display device by recording data corresponding to a frame memory in the graphic accelerator disposed outside the processor.

Another technical goal of the invention is to provide a graphic accelerator and a graphic accelerating method, which can easily improve the configuration of a system by externally changing an interface with a display device, without replacing a processor itself but with the minimum change.

Still another technical goal of the invention is to provide a graphic accelerator and a graphic accelerating method, which can improve a refresh rate and realize a greater display resolution.

According to an aspect of the invention, there is provided a graphic accelerator connected to a processor and a display device therebetween.

The graphic accelerator according to the aspect of the invention includes: a frame memory; an accelerator controller having the same interface as a memory of the processor on an input side and recording data, which should be transmitted from the processor to the display device, in the frame memory; and a display DMA (Direct Memory Access) transmitting the data recorded in the frame memory to the display device in a DMA manner.

The accelerator controller may input and output the data to and from the processor through an SDRAM interface.

The accelerator controller may analyze a writing command to the memory of the processor and may copy data corresponding to the writing command to the frame memory when the writing command is a writing command to a predetermined area in the memory. Here, the frame memory may be located on an extended memory map of the memory of the processor and the data may be recorded in a memory mapped access method.

The accelerator controller may receive a chip select signal for selecting the memory of the processor. The predetermined area may be a frame memory area in the memory. The accelerator controller may compare first position information of the frame memory area in the memory, which is input in advance, and second position information of the memory corresponding to the analyzed writing command to determine whether the writing command is a writing command to the frame memory area in the memory.

The graphic accelerator may further include at least one of a camera signal processing unit and a graphic signal processing unit connected to the frame memory to perform an updating operation.

The display DMA may transmit the data to the display device in accordance with a refresh rate of the display device or in response to a request.

According to another aspect of the invention, there is provided a graphic accelerating method of a graphic accelerator connected between a processor and a display device and a recording medium having recorded thereon a program for carrying out the graphic accelerating method.

The graphic accelerating method may include: inputting a writing command from the processor; and recording data to be transmitted from the processor to the display device in a frame memory when the writing command is input. The graphic accelerating method may further include a step of transmitting the data recorded in the frame memory to the display device in DMA manner in accordance with a refresh rate of the display device or in response to a request.

The graphic accelerating method may include: determining whether a writing command to a memory of the processor is input; determining whether the writing command is a writing command to a frame memory area in the memory when it is determined that the writing command is input; and copying data corresponding to the writing command to the frame memory when it is determined the writing command is a writing command to the frame memory area. The graphic accelerating method may further include a step of transmitting the data recorded in the frame memory to the display device in DMA manner in accordance with a refresh rate of the display device or in response to a request.

The step of determining whether the writing command is input may be performed on the basis of the input of a chip select signal for selecting a memory of the processor.

The step of determining whether the writing command is a writing command to a frame memory area in the memory may include comparing first position information of the frame memory area in the memory, which is input in advance, and second position information of the memory corresponding to the analyzed writing command to determine whether the writing command is a writing command to the frame memory area of the memory.

Other aspects, features, and advantages will become apparent from the accompanying drawings, the appended claims, and the detailed description.

In the graphic accelerator and the graphic accelerating method according to the invention, the memory bandwidth of a processor is not reduced even by continuous reading operations based on DMA transmission of a display device, by recording data corresponding to the frame memory in the graphic accelerator disposed outside the processor.

It is possible to easily improve the configuration of a system by externally changing an interface with a display device, without replacing a processor itself but with the minimum change.

It is also possible to improve a refresh rate and to realize a greater display resolution.

### BRIEF DESCRIPTION OF THE DRAWINGS

FIG. 1 is a block diagram illustrating the configuration of a processor connected to a display device to share a memory therewith.

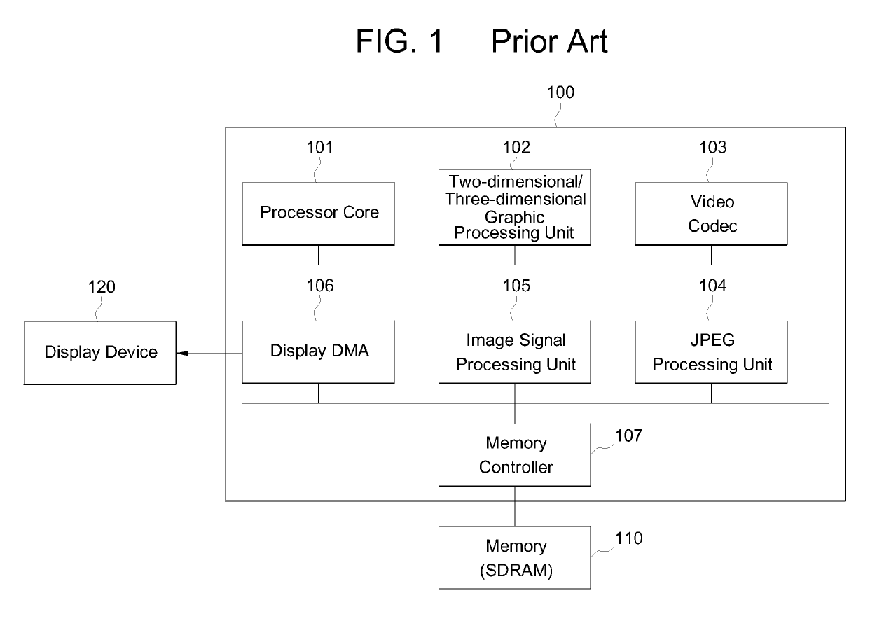

FIG. 2 is a block diagram illustrating the configuration of a processor including a particular frame memory therein.

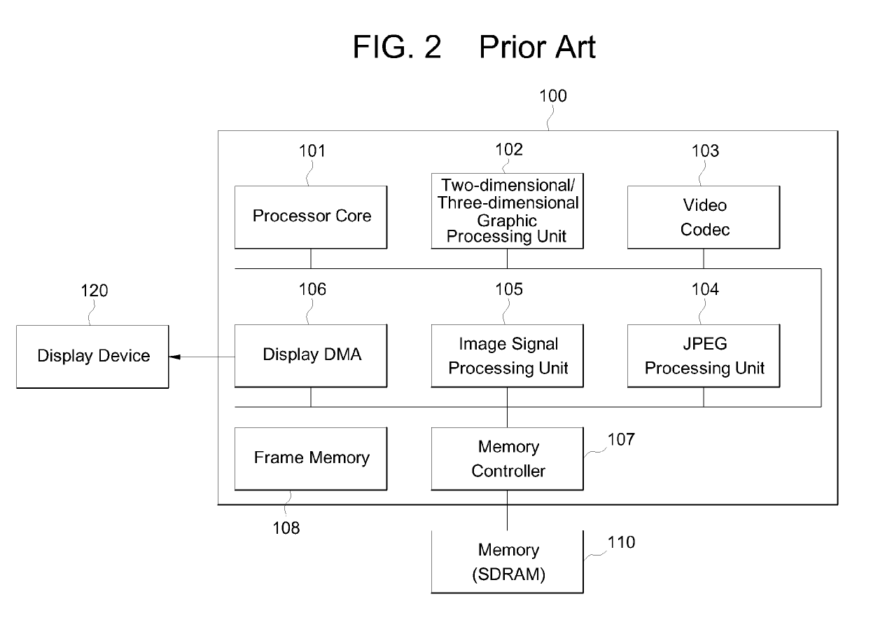

FIG. 3 is a block diagram illustrating the configuration of a graphic accelerator connected between a processor and a display device according to an embodiment of the invention.

FIG. 4 is a diagram illustrating a signal connection relation between a first memory and a second memory using a general memory mapped access method.

FIG. 5 is a diagram illustrating a signal connection relation between the processor and the graphic accelerator and the memory having the same memory interface according to an embodiment of the invention.

FIG. 6 is a diagram illustrating a connection relation among the processor, the graphic accelerator, and the display device according to an embodiment of the invention.

FIG. 7 is a flowchart illustrating a graphic accelerating method of the graphic accelerator according to an embodiment of the invention.

FIG. 8 is a flowchart illustrating a graphic accelerating method of the graphic accelerator according to another embodiment of the invention.

FIG. 9 is a block diagram illustrating the configuration of the graphic accelerator connected between the processor and the display device according to another embodiment of the invention.

### DETAILED DESCRIPTION

The above-mentioned goals, features, and advantages will become more apparent from the following detailed description with reference to the accompanying drawings.

The invention can be variously modified in various forms and specific embodiments will be described and shown in the drawings. However, the embodiments are not intended to limit the invention, but it should be understood that the invention includes all the modifications, equivalents, and replacements belonging to the spirit and the technical scope of the invention. When it is determined that detailed description of known techniques involved in the invention makes the gist of the invention obscure, the detailed description will be omitted.

Terms such as “first” and “second” can be used to describe various elements, but the elements are not limited to the terms. The terms are used only to distinguish one element from another element. For example, without departing from the scope of the invention, a first element may be named a second element and the second element may be named the first element, similarly. The term, “and/or”, includes a combination of plural elements or any one of the plural elements.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are used to merely describe specific embodiments, but are not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

So long as they are not defined differently, all the terms used therein, which include technical or scientific terms, have the same meanings as generally understood by those skilled in the art. The terms defined in dictionaries used in general should be analyzed to have the same meaning as in the contexts of the related art, but the terms should not be analyzed ideal or excessively formal.

Hereinafter, exemplary embodiments of the invention will be described in detail with reference to the accompanying drawings. Like or corresponding elements are referenced by like reference numerals regardless of the drawing number and repeated description thereof is omitted.

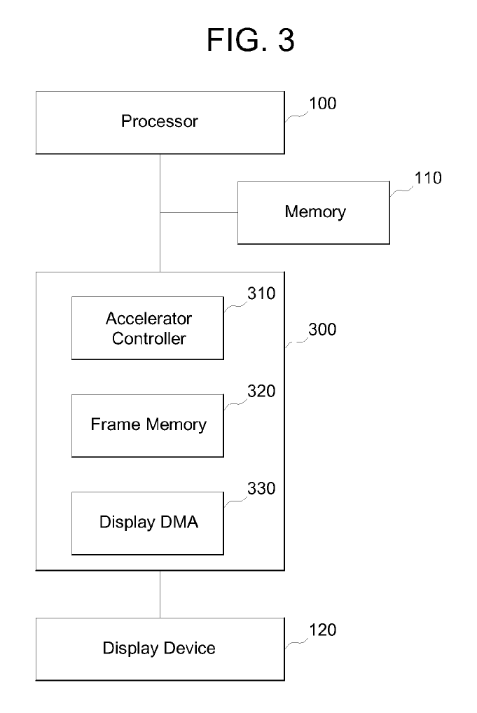

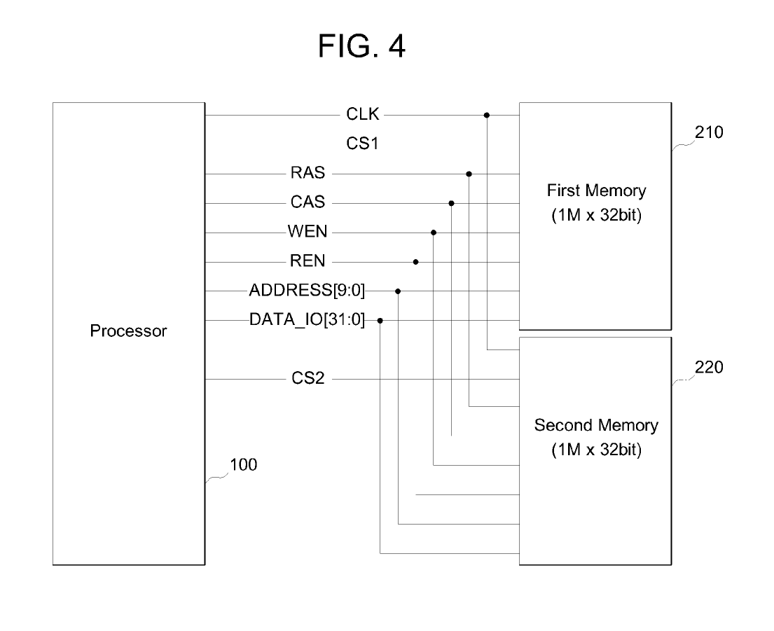

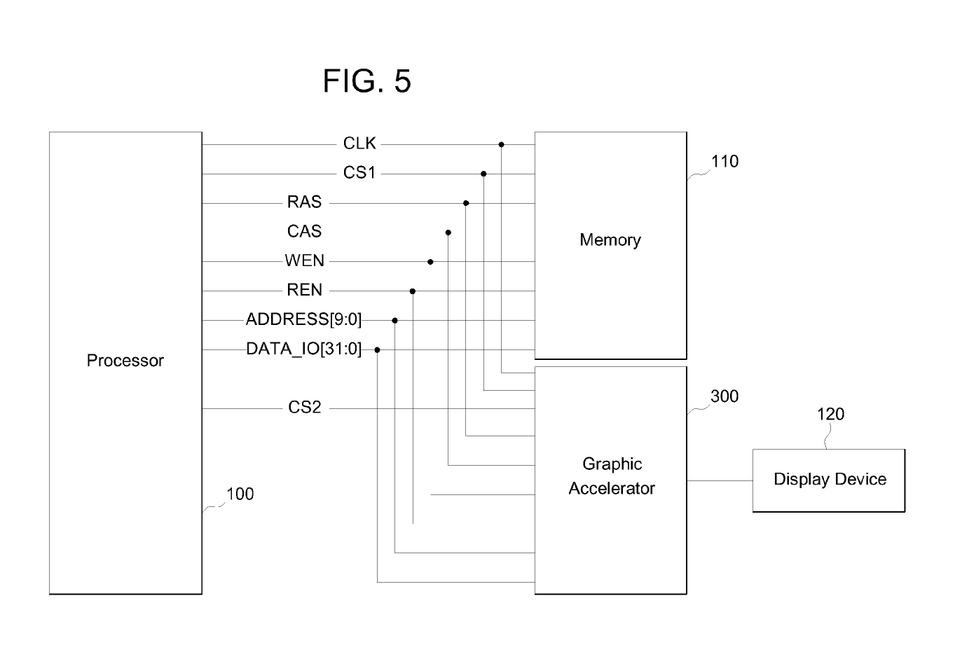

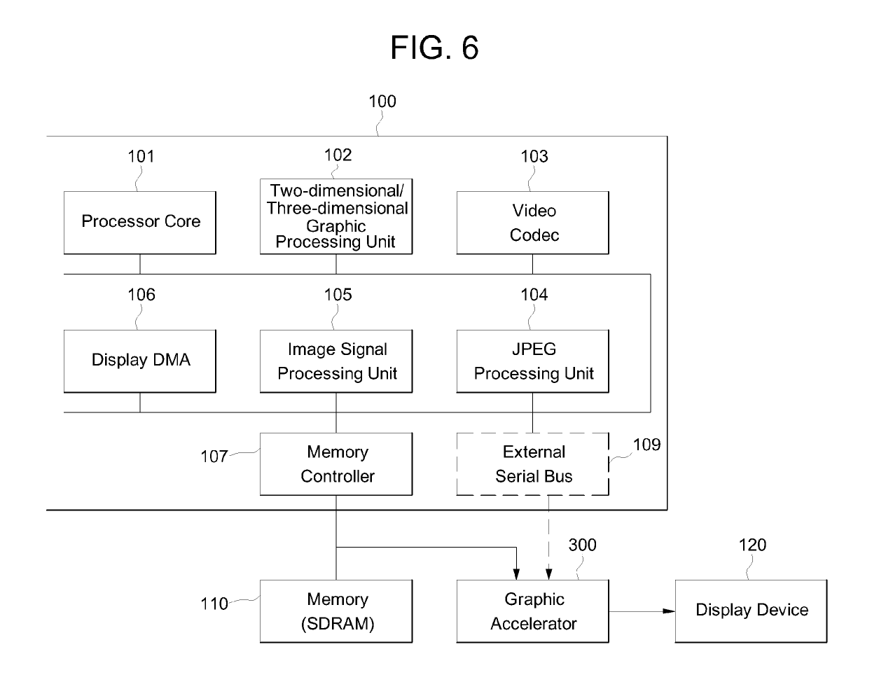

FIG. 3 is a block diagram illustrating the configuration of a graphic accelerator connected between a processor and a display device according to an embodiment of the invention. FIG. 4 is a diagram illustrating a signal connection relation between a first memory and a second memory using a general memory mapped access method. FIG. 5 is a diagram illustrating a signal connection relation between the processor and the graphic accelerator and the memory having the same memory interface according to an embodiment of the invention. FIG. 6 is a diagram illustrating a connection relation among the processor, the graphic accelerator, and the display device according to an embodiment of the invention.

Referring to FIG. 3, the graphic accelerator 300 is connected to a processor 100 and a display device 120 between the processor 100 and the display device 120.

The processor 100 may be a multimedia processor including a graphic processing unit, a video codec, a JPEG processing unit, and an image signal processing unit and being disposed in a mobile device (such as a mobile communication terminal and a smart phone). The display device 120 means a device such as an LCD, a TV, a projector, and a monitor receiving data and making a display.

In an embodiment, the graphic accelerator 300 includes an accelerator controller 310, a frame memory 320, and a display DMA 330. The processor 100 does not record data to be transmitted to the display device 120 in a memory 110 shared by the processing units as in the past, but directly transmits the data only to the graphic accelerator 300.

The accelerator controller 310 includes the same interface as the memory 110 on the input side thereof. The memory 110 of the processor 100 may be an SDR (Single Data Rate) or DDR (Double Data Rate) SDRAM. Therefore, the accelerator controller 310 can input and output data to and from the processor 100 via an SDR or DDR SDRAM interface.

The accelerator controller 310 receives a writing command directly from the processor 100 and records data corresponding to the writing command in a frame memory 320. The data to be recorded in the frame memory 320 relates to the details to be displayed on the display device 120 by the processor 100, that is, a predetermined image (still image or video) or the details obtained by updating an image displayed already.

The display DMA 120 transmits the data recorded in the frame memory 320 to the display device 120 in a DMA (Direct Memory Access) manner. The display DMA 120 may transmit the data recorded in the frame memory 320 to the display device 120 in accordance with a refresh rate or a request of the display device 120.

The reading operation to the display device 120 is carried out through the frame memory 320 of the graphic accelerator 300. The reading operation is performed regardless of the memory 110 shared by the processor 100, whereby the memory bandwidth of the memory 110 is not reduced.

In another embodiment, the graphic accelerator 300 includes an accelerator controller 310, a frame memory 320, and a display DMA 330. It is assumed that the processor 100 includes a memory 110 shared by the processing units thereof and a predetermined area in the memory 110 is allocated as a frame memory area for display. Accordingly, the processor 100 accesses the frame memory area of the memory 110 and records or updates data, when it is intended to display a predetermined image (still image or video) or to update the screen displayed already.

The accelerator controller 310 includes the same interface as the memory 110 connected to the processor 100 on the input side thereof. Thanks to the same interface, the accelerator controller 310 can recognize that the processor 100 performs a writing operation on the memory 110 using the writing command as described above. Here, the writing operation may include an updating operation.

The accelerator controller 310 may be connected to the processor 100 via a memory bus or via an external serial bus. When the accelerator controller is connected to the processor via the memory bus, the accelerator controller may share a part of the memory bus connected between the processor 100 and the memory 110.

After recognizing the writing command to the memory 110 from the processor 100, the accelerator controller 310 determines whether the writing command is a writing command to an area allocated as the frame memory area in the memory 110. When it is determined that the writing command is a writing command to the frame memory area, the accelerator controller 310 copies data, which is stored in the frame memory area of the memory 110, corresponding to the writing command to the frame memory 320.

Then, the reading operation to the display device 120 is performed on only the frame memory 320 of the graphic accelerator 300, not the memory 110. Accordingly, the memory bandwidth of the memory 110 shared by the processor 100 is not reduced.

The accelerator controller 310 includes an SDR or DDR SDRAM interface on the input side, which is preferably the same as the memory 110 of the processor 100.

To use the memory mapped access method, the accelerator controller 310 needs to include the same interface as the memory of the processor 100. The memory mapped access method is a method in which two or more memories distinguish the data access with a chip select signal while using a control signal and a data signal at the same time, which is mainly used to enhance the memory capacity.

Examples of the control signal include a read enable signal REN, a write enable signal WEN, a row address strobe RAS, a column address strobe CAS, and an address signal ADDRESS. The data signal is transmitted via a data input and output line DATA_IO. The chip select signal CS1 or CS2 is a kind of control signal and is used to select a specific memory.

Referring to FIG. 4, a first chip select signal CS1 is set to select a first memory 210 and the second chip select signal CS2 is set to select a second memory 220. The first chip select signal and the second chip select signal are not accessed at the same time due to general characteristics of a memory controller of the processor 100. One memory is mapped onto an address area of the other memory and is selected only when the corresponding memory address is accessed. For example, in 0 to 1M, only the first memory 210 is activated and the second memory 220 is disabled, by the first chip select signal.

Referring to FIG. 5, the first memory 210 corresponds to the memory 110 shared by the processor 100 and the second memory 220 corresponds to the graphic accelerator 300. When a predetermined area in the memory 110 is subjected to a writing operation (including an updating operation) as a frame memory area, the graphic accelerator 300 recognizes that the writing operation is performed on the corresponding address and operates to write the same details in the frame memory 320 therein. In this case, since the graphic accelerator 300 should recognize that the writing operation is performed on the memory 110, the first chip select signal CS1 has to be connected thereto additionally.

The graphic accelerator 300 recognizes that the writing operation is performed on the memory 110 of the processor 100 via the memory bus. This operation is performed by the accelerator controller 310. The accelerator controller 310 includes a particular storage and first position information on the address and size of the frame memory area located in the memory 110 is input thereto in advance.

When recognizing the writing operation on the memory 110, the accelerator controller 310 acquires second position information on the memory 110 involved in the present writing operation via the memory bus. Therefore, the accelerator controller 310 compares the first position information with the second position information. That is, the accelerator controller compares the address and size of the frame memory area located in the memory 110 and input in advance with the information on the address of the memory 110 involved in the writing operation. When the present writing operation is carried out in the frame memory area, the same data is copied to the frame memory 320 in the graphic accelerator 300.

In another embodiment, the accelerator controller 310 may receive information on the address of the memory 110 in which the present writing operation is performed via an external serial bus 109 (for example, a serial peripheral interface (SPI)) of the processor 100.

The display DMA 330 of the graphic accelerator 300 transmits the data recorded in the frame memory 320 to the display device 120 in a DMA manner periodically or in response to a request. The display device 120 does not access the memory 110 of the processor 100, but accesses only the frame memory 320 of the graphic accelerator 300 to perform the reading operation.

Since the display DMA 330 of the graphic accelerator 300 performs the above-mentioned operation, the display DMA 330 of the processor stops its functions. In this case, only the function of the display DMA 330 of the processor 100 can be stopped, thereby minimizing the change in software in the processor 100.

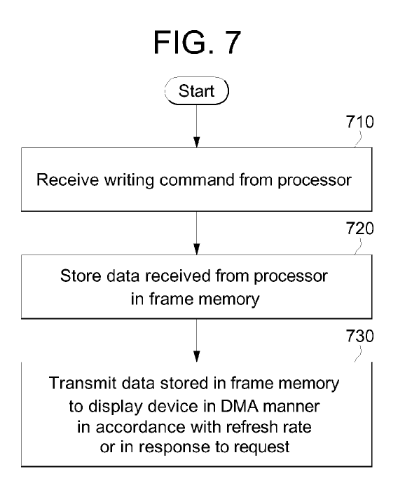

FIG. 7 is a flowchart illustrating a graphic accelerating method of the graphic accelerator according to an embodiment of the invention. The accelerator controller 310 includes the same interface as the memory 110 of the processor 100 and is connected to the processor 100.

Since the accelerator controller 310 includes the same interface as the memory 110, it can also receive a writing command from the processor 100 (step 710). Here, the writing command also includes a command for updating data recorded in the frame memory 320.

The accelerator controller 310 stores the data input from the processor 100 in the frame memory 320 in response to the input writing command (step 720).

Thereafter, the data stored in the frame memory 320 is transmitted to the display device 120 in a DMA manner in response to a periodic request based on the refresh rate of the display device 120 or an arbitrary request (step 730).

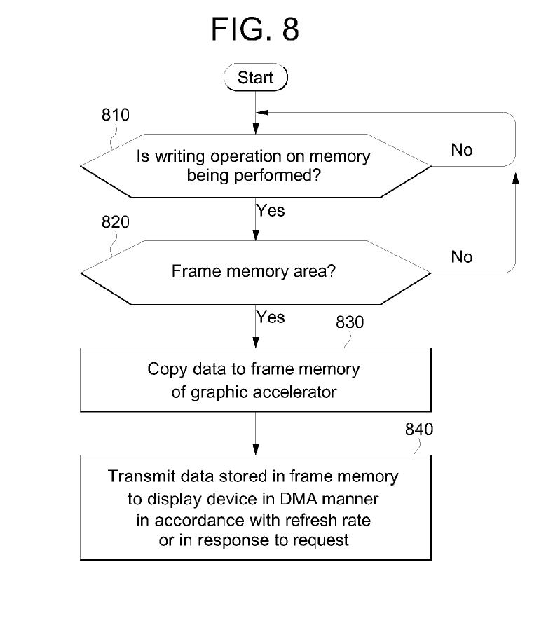

FIG. 8 is a flowchart illustrating a graphic accelerating method of the graphic accelerator according to another embodiment of the invention. Here, the accelerator controller 310 is connected to the memory controller 107 of the processor 100 via the memory bus. Particularly, as shown in FIG. 5, the first chip select signal for selecting the memory 110 of the processor 100 is also input to the accelerator controller 310.

The accelerator controller 310 determines whether the writing operation to the memory 110 of the processor 100 is being performed on the basis of the input of the first chip select signal (step 810). When it is determined that the writing operation is not being performed, the process of step 810 is repeated until the first chip select signal is input.

When the first chip select signal is input and the writing operation is being performed on the memory 110 of the processor 100, the accelerator controller 310 determines whether the area of the memory 110 involved in the writing operation is the frame memory area involved in the display (step 820). When it is determined that the writing operation is performed on an area other than the frame memory area, the process of step 810 is performed again.

On the basis of the address and size of the frame memory area input in advance to the accelerator controller 310, it can be determined whether the area being subjected to the writing operation is the frame memory area.

When it is determined that the area of the memory 110 involved in the writing operation is the frame memory area, the accelerator controller 310 copies the data recorded in the memory 110 of the processor 100 to the frame memory 320 of the graphic accelerator 300 via the memory bus (step 830).

Thereafter, the data copied to the frame memory 320 of the graphic accelerator 300 is transmitted to the display device 120 in a DMA manner in accordance with the refresh rate of the display device 120 or in response to a request and is displayed thereon (step 840).

Recently, there is a need for installation of two or more display devices. When the number of display devices increases, the memory bandwidth for the display also increases. However, a configuration in which the memory bandwidth of the main memory of the processor is not reduced in spite of the increase in memory bandwidth for the display is necessary.

In this case, by displacing the frame memory to the outside of the processor using the graphic accelerator and the graphic accelerating method according to the embodiments of the invention, it is possible to freely utilize the memory bandwidth in the processor and to cope with various requirements involved in the function of often updating the display and the frame memory.

For example, an LCD out of display devices mainly uses a parallel bus, but the parallel bus tends to be replaced with a new serial interface such as an MIPI (Mobile Industry Processor Interface) or an MDDI (Mobile Display Digital Interface). However, in the past, there was a problem in that the processor itself should be replaced. According to the embodiments of the invention, since the corresponding interface can be externally changed with the minimized change, it is possible to easily improve the configuration of a system.

Various interfaces of newly-required display devices such as HDMI (High Definition Multimedia Interface) and USB which are interfaces of NTSC or PAL TV and HDTV have the same problem. In this case, since the corresponding interface can be externally changed with the minimum change by employing the embodiments of the invention, it is possible to easily improve the configuration of a system.

When the frame memory of the graphic accelerator is used to perform a reading operation of the display device, the memory bandwidth is great, thereby improving the refresh rate and realizing a higher display resolution. Since the breaking in a large screen cannot be recognized with the high refresh rate, it is possible to manufacture a display device providing natural visibility.

On the other hand, the graphic accelerating method of a graphic accelerator described above with reference to FIG. 7 or 8 can be embodied by a computer program. Codes and code segments of the program will be easily obtained by programmers skilled in the art. The program can be stored in a computer-readable recording medium and can be read and executed by a computer to embody the graphic accelerating method of a graphic accelerator. The recording medium includes a magnetic recording medium, an optical recording medium, and a carrier wave medium.

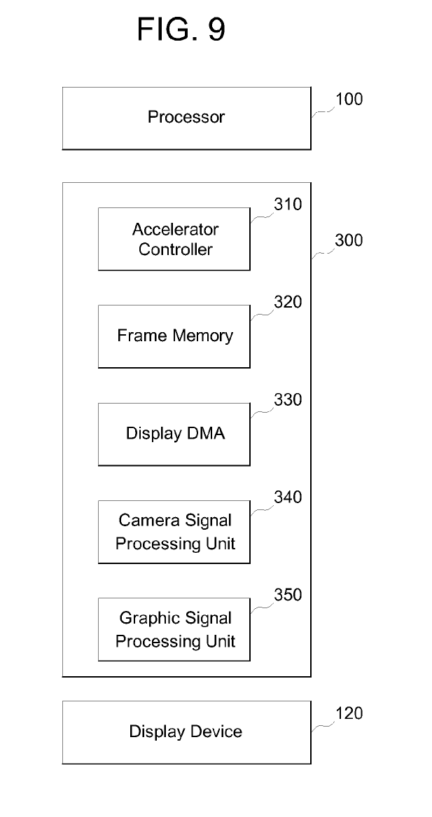

FIG. 9 is a block diagram illustrating the configuration of the graphic accelerator connected between a processor and a display device according to another embodiment of the invention. The functions of the accelerator controller 310, the frame memory 320, and the display DMA 330 are the same as shown in FIG. 3 and thus will not be described.

The graphic accelerator 300 may further include a camera signal processing unit 340 and/or a graphic signal processing unit 350 which should often update the frame memory 320.

Since the camera signal processing unit 340 and/or the graphic signal processing unit 350 connected to a camera module are disposed in the graphic accelerator 300 independently of the processor 100, the often updating of the frame memory 320 does not affect the memory bandwidth of the processor 100.

While the invention is described with reference to the exemplary embodiments, it will be understood by those skilled in the art that the invention is modified and changed in various forms without departing from the spirit and scope of the invention described in the appended claims.

1. A graphic accelerator connected to a processor and a display device therebetween, comprising:
a frame memory;
an accelerator controller having the same interface as a memory of the processor on an input side and recording data, which should be transmitted from the processor to the display device, in the frame memory; and
a display DMA (Direct Memory Access) transmitting the data recorded in the frame memory to the display device in a DMA manner.

2. The graphic accelerator according to claim 1, wherein the accelerator controller inputs and outputs the data to and from the processor through an SDRAM interface.

3. The graphic accelerator according to claim 1, wherein the accelerator controller analyzes a writing command to the memory of the processor and copies data corresponding to the writing command to the frame memory when the writing command is a writing command to a predetermined area in the memory.

4. The graphic accelerator according to claim 3, wherein the accelerator controller receives a chip select signal for selecting the memory of the processor.

5. The graphic accelerator according to claim 3, wherein the predetermined area is a frame memory area in the memory.

6. The graphic accelerator according to claim 5, wherein the accelerator controller compares first position information of the frame memory area in the memory, which is input in advance, and second position information of the memory corresponding to the analyzed writing command to determine whether the writing command is a writing command to the frame memory area in the memory.

7. The graphic accelerator according to claim 3, wherein the frame memory is located on an extended memory map of the memory of the processor and the data is recorded in a memory mapped access method.

8. The graphic accelerator according to claim 1, further comprising at least one of a camera signal processing unit and a graphic signal processing unit connected to the frame memory to perform an updating operation.

9. The graphic accelerator according to claim 3, wherein the display DMA transmits the data to the display device in accordance with a refresh rate of the display device or in response to a request.

10. A graphic accelerating method of a graphic accelerator connected between a processor and a display device, comprising:
inputting a writing command from the processor; and
recording data to be transmitted from the processor to the display device in a frame memory when the writing command is input.

11. The graphic accelerating method according to claim 10, further comprising a step of transmitting the data recorded in the frame memory to the display device in DMA manner in accordance with a refresh rate of the display device or in response to a request.

12. A graphic accelerating method of a graphic accelerator connected between a processor and a display device, comprising:
determining whether a writing command to a memory of the processor is input;
determining whether the writing command is a writing command to a frame memory area in the memory when it is determined that the writing command is input; and
copying data corresponding to the writing command to the frame memory when it is determined the writing command is a writing command to the frame memory area.

13. The graphic accelerating method according to claim 12, further comprising a step of transmitting the data recorded in the frame memory to the display device in DMA manner in accordance with a refresh rate of the display device or in response to a request.

14. The graphic accelerating method according to claim 12, where the step of determining whether the writing command is input is performed on the basis of the input of a chip select signal for selecting a memory of the processor.

15. The graphic accelerating method according to claim 12, wherein the step of determining whether the writing command is a writing command to a frame memory area in the memory includes comparing first position information of the frame memory area in the memory, which is input in advance, and second position information of the memory corresponding to the analyzed writing command to determine whether the writing command is a writing command to the frame memory area of the memory.

16. (canceled)
